(19) United States
(12) Patent Application Publication
(10) Pub. No.: US 2009/0222201 A1
(43) Pub. Date: Sep. 3, 2009

(54) DEVICE AND METHOD FOR OUTPUTTING ROUTING INFORMATION OF A NAVIGATION SYSTEM

(76) Inventor: Thomas Jung, Bielefeld (DE)

Correspondence Address: KENYON & KENYON LLP, ONE BROADWAY, NEW YORK, NY, 10004, US

(21) Appl. No.: 12/088,966

(22) PCT Filed: Oct. 13, 2006
(86) PCT No.: PCT/EP2006/067375

§ 371 Date: Sep. 10, 2008

(30) Foreign Application Priority Data
Dec. 1, 2005 (DE) 10 2005 057 263.4

(51) Int. Cl. G01C 21/36

(52) U.S. Cl. 701/207; 701/200

(57) ABSTRACT

To provide a navigation system having a locating unit, a database, a route calculation unit, an input device and an output device for routing, whose user-friendliness is enhanced and the traffic safety is improved, an evaluation unit is provided for determining the need for outputting routing information. Furthermore, a corresponding method is provided.

### FIELD OF THE INVENTION

The present invention relates to a navigation system having a locating unit, a database, a route calculation unit, an input device and an output device for routing, as well as to a method for outputting routing information.

### BACKGROUND INFORMATION

In particular for high-end motor vehicles, navigation systems or driver information systems are being increasingly used. Using a navigation system, it is possible to easily find even unknown locations or roads in other cities without the danger of getting lost. For this purpose, the navigation system has a locating unit which is able to determine, with the aid of the GPS system or, in the future, of the Galileo system, the position of the navigation system, i.e., of the motor vehicle equipped therewith on the earth's surface, with sufficient accuracy. Furthermore, the navigation system has a database which is stored, for example, on a removable CD-ROM, in which all information relevant to the trip regarding the road network of the area currently traveled is stored. Furthermore, additional information such as the position of hotels, rest stops, landmarks, or the like may be stored here. The user of the navigation system may input the desired destination via an input device, a route from the starting point to the desired destination being calculated by the navigation system, i.e., by its route calculation unit. Vehicle-specific or user-specific parameters such as the exclusion of toll roads may be taken into consideration. For routing the user, visual and/or acoustic routing information is output by an output device, in the form. of a voice message, for example, or as a directional arrow on a display of the navigation system.

Furthermore, a home address or a frequently used destination such as a business location may be input in navigation systems in order to avoid complicated reprogramming of this often-used destination.

The routing information is output by the navigation system as a function of the route, so that the direction to be followed in city traffic before and at each intersection is predefined. For longer highway or cross-country trips, usually only a one-time instruction is given, for example, in the form that the road is to be followed for a long time.

The disadvantage here is that, in particular in the neighborhood of a home address, a user of the navigation system has so much knowledge of the locale that the output of routing information is no longer needed and may even be considered annoying.

### SUMMARY

An object of the present invention is to provide a navigation system whose user-friendliness is enhanced and which contributes to enhancing traffic safety. Furthermore, a corresponding method for outputting routing information is provided.

According to example embodiments of the present invention, a navigation system has an additional evaluation unit using which a need for outputting routing information may be ascertained. If this evaluation unit determines that the output of routing information is not necessary, it is not output in order not to distract the user of the navigation system from the traffic scene with a superfluous deluge of information. This means that, for example, in the immediate neighborhood of the user's residence routing information is no longer output because the user is normally familiar with the desired driving route in this case.

Within the framework of the present invention, different evaluation criteria for determining whether or not routing information is to be output may be used, but preferably those described below.

An advantage of the present invention is that the navigation system may be adapted to the requirements of a user via the differentiated output of routing information, so that its use is subjectively considered comfortable. For this purpose, in the immediate surroundings of a locale known to the user, the user is not distracted by unnecessary information; this enhances traffic safety.

In an advantageous specific embodiment, routing information is no longer output within a radius around the selected destination. For this purpose, the current position is compared with the actual distance. from the destination previously input by the user and, using the horizontal distance, it is determined whether the actual distance is less than the radius within which routing information is no longer to be output. This radius is preferably adaptable by the user to his individual needs. For example, the user may input his home address as the destination, and a distance of 10 km as the radius, so that when he approaches his home address, he receives no more routing information, since he is supposed to know his way in this area.

For adapting to different circumstances, in accordance with example embodiments of the present invention, on the basis of the destination entered and the current distance therefrom, the routing information be output less frequently when approaching the destination by a preferably also adjustable gradient. For example, at a distance of 20 km from the destination, the full number of routing instructions may still be output; at a 10 km distance only one-half, for example, only rough directional information, and on reaching the destination, no more routing information. This gradient does not have to follow a linear curve, but rather the amount of routing information output may be reduced stepwise for example.

According to example embodiments of the present invention, the user may also input a plurality of destinations to which he frequently travels, for example, his home address and business address, possibly with different radii for each, so that when he approaches these destinations he is not burdened with superfluous information.

According to a specific embodiment, a user himself may adapt the navigation system to his needs by determining the number of routing instructions output by the navigation system. The number of pieces of information received may thus be reduced when he only needs rough directional information to reach his desired destination when traveling on a highway for example. However, if he needs more frequent routing information in a strange city, he may prompt the system to provide it.

Of course, the output of routing information may continue when approaching a known destination if so desired by the user, i.e., the output is not suppressed.

### BRIEF DESCRIPTION OF THE DRAWING

An exemplary embodiment of the present invention is explained in greater detail below with reference to the FIGURE.

FIG. 1 shows a schematic flow chart of the mode of operation of the navigation system.

### DETAILED DESCRIPTION OF EXAMPLE EMBODIMENTS

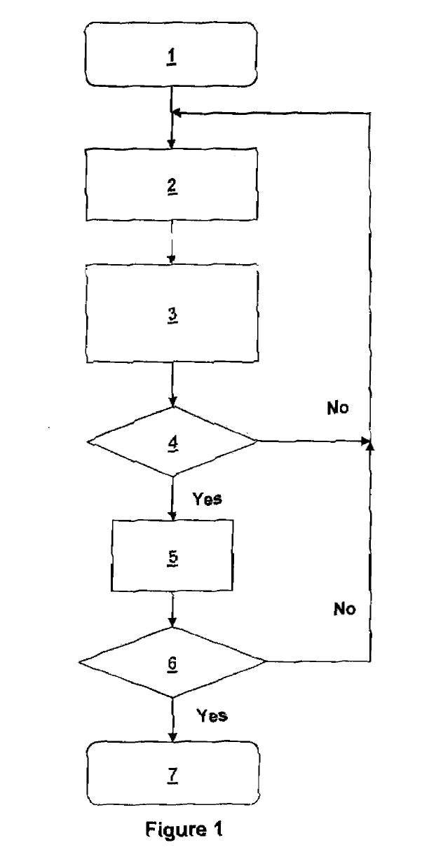

FIG. 1 schematically shows the basic routing sequence of a navigation system. The routing starts at step 1. A travel route from the current position determined in step 2, which is established with the aid of a locating unit, to a destination selected by the user via an input device is calculated by a route calculation unit using the criteria selected by the user, with the help of the route information contained in the database. The corresponding routing information is communicated to the user via visual and/or acoustic output devices.

An evaluation unit is also provided, which checks, in a step 3, whether or not routing information is to be output. A decision is made in step 4 of whether or not the instruction is output and then an instruction such as “continue on this road” is prepared. This instruction is then output in step 5. The output of routing information may be suppressed, for example, when the desired destination, for example, the home address, is within a radius of 10 km because in this area around the destination the user needs no more routing information.

When the destination is reached, which may be ascertained in step 6 by the locating unit by comparison with a predefined travel destination, this may be confirmed via a final message by the navigation system; this last routing information may also be suppressed. Subsequently the routing by the navigation system is terminated in step 7.

1-10. (canceled)

11. A navigation system comprising:
a locating unit;
a database;
a route calculation unit coupled to the locating unit and the database;
an input device and an output device coupled to the route calculation unit; and
an evaluation unit adapted to ascertain a need for outputting routing information.

12. The navigation system as recited in claim 11, wherein the evaluation unit is adapted to suppress the output of routing information within an adjustable radius around a destination.

13. The navigation system as recited in claim 11, wherein a number of routing instructions output is reduced by an adjustable gradient when approaching a destination.

14. The navigation system as recited in claim 11 wherein different destinations are able to be input via the input device.

15. The navigation system as recited in claim 11, wherein a total number of routing instructions output is adjustable.

16. A method for outputting routing information in a navigation system, comprising:
evaluating the routing information to determine whether its output is necessary.

17. The method as recited in claim 16, further comprising:
suppressing the output of routing information within an adjustable radius around a destination.

18. The method as recited in claim 16, further comprising:
reducing a number of routing information items output by an adjustable gradient when approaching a destination.

19. The method as recited in claim 16, further comprising:
selecting different destinations.

20. The method as recited in claim 16, further comprising:
adjusting a number of routing information items output.
